(19) United States
(12) Patent Application Publication
(10) Pub. No.: US 2015/0302380 A1
(43) Pub. Date: Oct. 22, 2015

(54) PROCESS, SYSTEM, AND METHOD FOR PRINTING RECEIPT BASED ON CONSUMER PURCHASES

(71) Applicants: Yadvender Singh Kalsi, Eastvale, CA (US); Lou Paik, Orange, CA (US)

(72) Inventors: Yadvender Singh Kalsi, Eastvale, CA (US); Lou Paik, Orange, CA (US)

(21) Appl. No.: 14/566,699

(22) Filed: Dec. 10, 2014

Related U.S. Application Data
(60) Provisional application No. 61/913,916, filed on Dec. 10, 2013.

(51) Int. Cl. G06Q 20/20; G06Q 20/38; G06Q 30/02

(52) U.S. Cl. CPC G06Q 20/209; G06Q 30/0222; G06Q 20/387

(57) ABSTRACT

The present invention provides a method for creating and delivering recipes, incentives, and/or other valuable enhancements in response to purchases or inquiries of products such as by printing over various printable media in various departments within a retail store through a computer and/or communication network, such as at kiosks. Other features of the invention permit the use of customer information using consumer identifiers, shopping histories, with and without printing of possible recipes, incentives or other enhancements or enticements for statistical information and/or inputs.

### CROSS-REFERENCE TO RELATED APPLICATION

The application claims priority from U.S. Provisional Patent Application No. 61/913,916, filed on Dec. 10, 2013, the contents of which are incorporated herein by reference.

### BACKGROUND OF THE INVENTION

It has been estimated that over ten thousand new products are introduced each year in retail stores. Each new item typically has only a very short time in which to demonstrate its marketing viability. With appropriate item selections, filtered sales data allow vendors to obtain specific product sales performance, either alone or in conjunction with complementary products.

Sales data for specific items may help the vendor to monitor the progress of promotional product displays, special offers, and the like. Item movement data would allow the vendor to determine whether or not a promotional display or other promotional feature was built and, if built, the degree of its impact on product sales.

Filtering sales data by item also permits a vendor to perform a retail price point sensitivity analysis. This may encourage establishment of retail prices that promote high vendor volume while improving retailer profitability.

It would be advantageous to provide a point-of-sale data processing system that would include one or more of the features of 1) scanning (or inputting) data on an item at a point-of-sale location; 2) printing a receipt with a recipe and/or incentive information based on the product data and consumer data; 3) transmitting relevant information from the consumer transaction to a designated server; and 4) transmitting information on receipt from a kiosk, a register, a vending machine, or other location and/or kiosk, register, vending machine, or other types of incentive delivery mechanisms.

### SUMMARY OF THE INVENTION

In one aspect of the present invention, a method for printing receipts may comprise; scanning items at a point-of-sale, checking for triggers using point-of-sale processors from a compiled list of trigger matches, gathering a category of items based on trigger matches, determining whether recipe triggers exist, determining whether incentive triggers exist, presenting a receipt, updating a counter in a point-of-sale system when presenting a receipt, determining whether a brand aware option is enabled, and print a receipt with recipe and/or incentive information.

In another aspect of the present invention, a method for distributing an incentive may comprise; scanning an item at a point-of-sale during a consumer transaction, transmitting relevant information from the consumer transaction to a designated server, displaying general footer and header navigation, verifying scanner or input code data, determining whether the scanner or input code data is present in the designated server, determining whether the scanner or input code data was used previously, extracting information from the scanner or input code data into relevant fields, recording the scanner or input code data, recording the transaction, and issuing information on a printed receipt regarding collecting an incentive.

In a further aspect of the present invention, a method for distributing an incentive may comprise; analyzing a prospective purchaser and purchaser activities, selecting threshold criterion for an item, generating a random length of time, prompting the prospective purchaser to make an offer for the item, determining whether an offer meets the threshold criterion, comparing the elapsed time with the random length of time, and accepting the prospective purchaser's recent offer.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is a schematic block diagram of a system and information flow, according to an embodiment of the present invention;

FIG. 2 is a block diagram of a system and information flow, according to another embodiment of the present invention;

FIG. 3 is a block diagram of cloud services, point of sale processors, and a communication network, according to yet another embodiment of the present invention;

FIG. 4 is a flowchart of a method for a recipe/incentive process and algorithm, along with a brand aware option, according to still another embodiment of the present invention;

FIG. 5 is a flowchart of another method, according to a further embodiment of the present invention;

FIG. 6 is a flowchart of a yet another method, according to a still further embodiment of the present invention; and

FIG. 7 is a flowchart of a method for receipt processing, according to a yet further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates generally to extracting point-of-sale data. Specifically, the invention relates to presenting recipes, incentives, rebates, and other enhancements on sales receipts coordinated with information regarding a purchaser and the items purchased. Although several example below refer to specific uses of the invention for printing cooking recipes on receipts, it should be understood that the examples are also suitable for similar uses, such as providing receipts with incentives (e.g., loyalty points, redeemable gifts, rebates), or any other enhancements to the POS transactions. Data from various points in the flow and methods may be collected and stored electronically for data mining and analysis. Such collected data may be shared using various methods with customers, end users, third parties, marketing entities, public relations entities, or other parties for various purposes. Examples regarding scanning may be modified to account for manually inputting data at a POS.

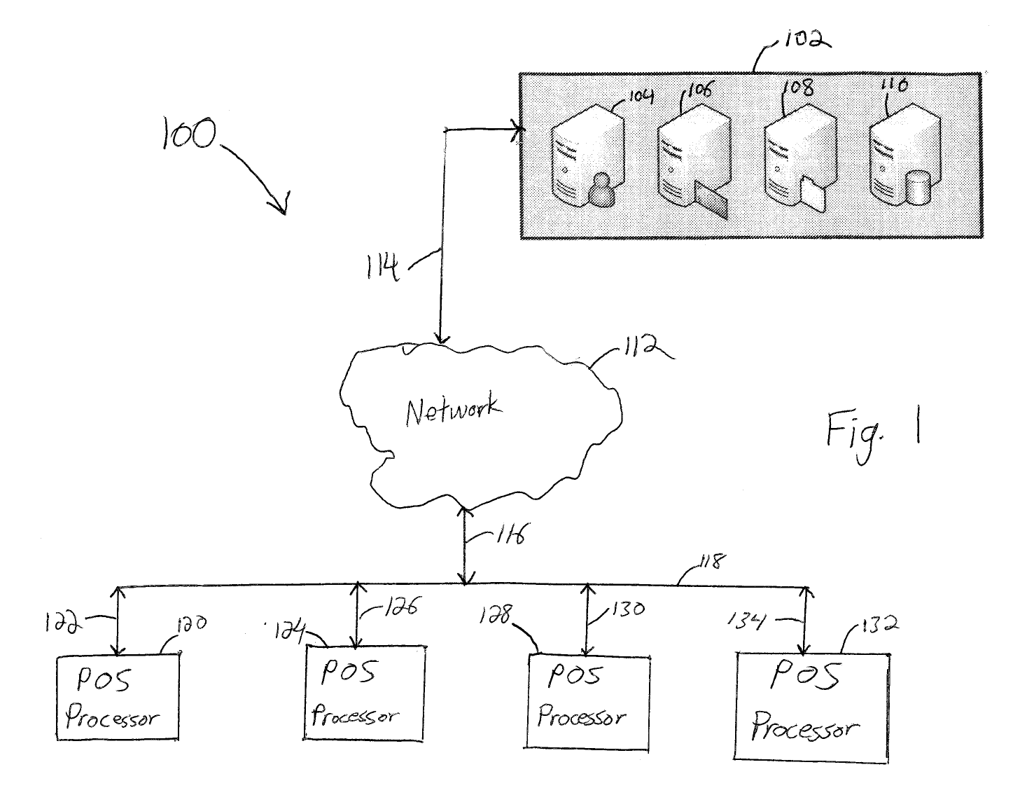

Referring now to the drawings in detail, wherein like reference characters refer to like elements, there is shown in FIG. 1 a block diagram of a system and information flow 100 that may benefit from embodiments of the present invention.

As shown, a central processing center 102 may comprise servers 104, 106, 108, 110 which may be used as receipt information cloud services. The system 100 may accept inputs from all types of point-of-sale processors 120, 124, 128, 132. Communication lines 122, 126, 130, 134 may serve for communication (wired or wireless) with information trunk 118, which may then communicate along communication path 116 with a network 112. In kind, the network 112 may communicate via communication path 114 with the central processing center 102. Network 112, may be any type of wired or wireless network, perhaps the Internet. This system 100 may process the data as per the configurations contained therein and send the results back to the point-of-sale processors 120,124,128,132 for outputs. The system 100 may scale for large-scale implementation serving, for example, thousands of point-of-sale processors and thousands of retail customers at a given point of time. Multiple campaigns or programs may be configured to run simultaneously for a plurality of stores and a plurality of retail customers. Depending on customer requirements and a given information technology environment, the central processing center 102 may be flexible and may be configured to accommodate local, hosted, third party, or cloud services implementation using various hardware configurations with scattered or centralized software processes and storage. The system 100 may also be configured to serve one client per system or multiple clients per system. Further components may be spread into clusters of systems to accommodate large scale implementations. Extensive software and hardware design provisions accommodate disaster recovery and business continuity plans for the system 100. The system 100 may be configured for off-site and on-site backups and synchronizations (e.g., synchronization of database(s) within various counterparts locally or remotely). The system may use various software development languages, databases, and services that have front-end and back-end services. The system 100 may be maintained on various tiers of security levels within the system 100 for accessing information from within and from outside the system 100.

Each POS Processor 120,124,128,134 may comprise a point-of-sale processor. A point-of-sale (also called “POS” or “checkout”) is the place where a transaction is completed. It is the point at which a customer makes a payment to the merchant in exchange for goods or services. The POS may be a cash register, a vending machine, a kiosk, an automated teller machine (ATM) or any other suitable place or machine for conducting a transaction. At the point-of-sale, a retailer may calculate the amount owed by the customer and provide options for the customer to make payment. The merchant may also normally issue a receipt for the transaction. The point of sale processor in various retail industries uses customized hardware and software as per their requirements. Retailers may use weighing scales, scanners, electronic and manual cash registers, EFTPOS terminals, touch screens, and any other variety of hardware and software available for use with point-of-sale processor or POS.

For example, a grocery or candy store uses a scale at the point-of-sale, while bars and restaurants use software to customize the item or service sold when a customer has a special meal or drink request. Many small merchants and even mid-sized ones are looking for mPOS (mobile point of sale processor) systems because of the cost effectiveness, functionality, and easy implementation. The modern point-of-sale is often called the Point-of-Service because it is not just a point of sale but also a point of provision of services, item returns, or customer orders. Additionally POS includes advanced features to cater to different functionality, such as inventory management, CRM, financials, warehousing, and so on, all built into the point-of-sale processor or POS software.

The POS Processors 120,124,128,132 may use a software module with two separate but integrated components; first being the software spooler (printer services extractor); child module; and the second; being the recipe receipt parent module.

Network 112 may be a computer and/or communication network proposed to be used in various capacities to provide communication channels between various sub-systems of system 100. The network 112 may comprise a variety of network technologies like MPLS, Mobile or cellular based networks (e.g., 3G/4G), VPN over Internet, Metro Ethernets, private, public, Point-to-Point links, Point to Multi-point links and so on. The basic purpose of the system 100 is to provide wide area connectivity between various recipe receipt systems.

Information trunk 118 may be a communication network that is local to the retail customer area also called local area networks (LAN). These types of networks may be constructed to provide communication between local computers and infrastructure equipment like switches and routers to provide communication between each other.

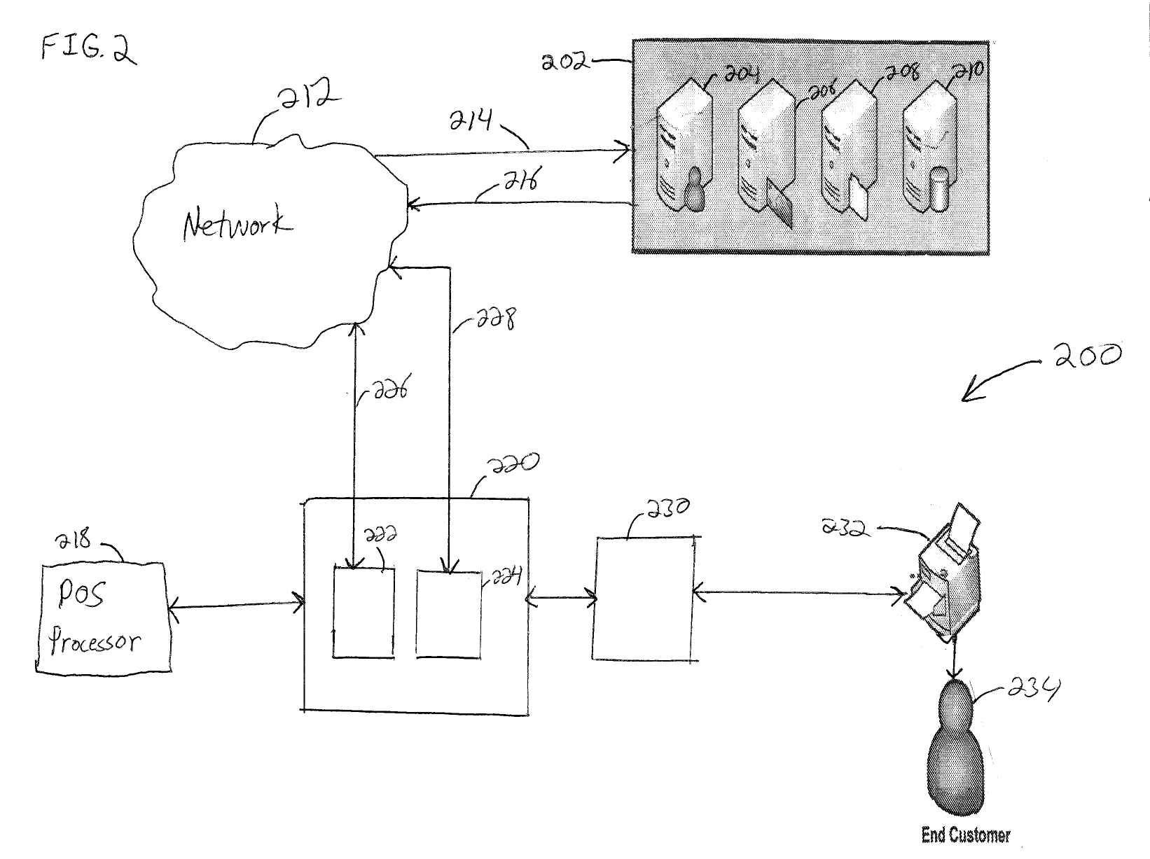

FIG. 2 is a simplified block diagram depicting components of a system 200 and the information flow; showing the recipe receipt cloud services 202, point of sale processor 218 loaded with the recipe receipt processor 220 and communication network 212. Central processing center 202 for the system 200 may comprise hardware, software, and communications platforms. The software may accept inputs from point-of-sales processor systems via recipe receipt processors 222,224. The servers 204,206,208,210 in the central processing center 202 may process data and transmit results back to the recipe receipt processors 222,224 for outputs.

Recipe receipt processor 220 may comprise a software module with two separate but integrated components 222,224. The first component may be a software spooler (printer services extractor); child module 222, while the second; may comprise a recipe receipt parent module 224. As shown in the diagram, the software spooler (printer services extractor); child module 222; may receive prints from the point of sales processor 218 and send data internally to the second component of the recipe receipt processor; the recipe receipt parent module 224. The recipe receipt parent module 224 may then send processed data to the recipe receipt cloud services 202 via communication links 228 to network 212. Network 212 may communicate to and from the recipe receipt cloud services 202 via communication links 214,216 for further processing to pick a random recipe for the customer. The recipe receipt cloud services 202 may append, embed, and integrate random recipes from servers 204,206,208,210 to print on a copy of a sales receipt and send data back to the recipe receipt parent module 224. The recipe receipt parent module 224 may send data back to the software spooler (printer services extractor); child module 222. The software spooler (printer services extractor); child module 222 may check for a default configured printer in the operating system and send the complete receipt to a printer for printing. A hardware spooler 230 may be used in the printing process.

A POS Processor Printer 230 may serve to print a receipt, with recipes, incentives, enhancements, and such, for an end customer 234. A variety of manufacturers offer POS printer portfolios with various features and functionality—including thermal receipt printing.

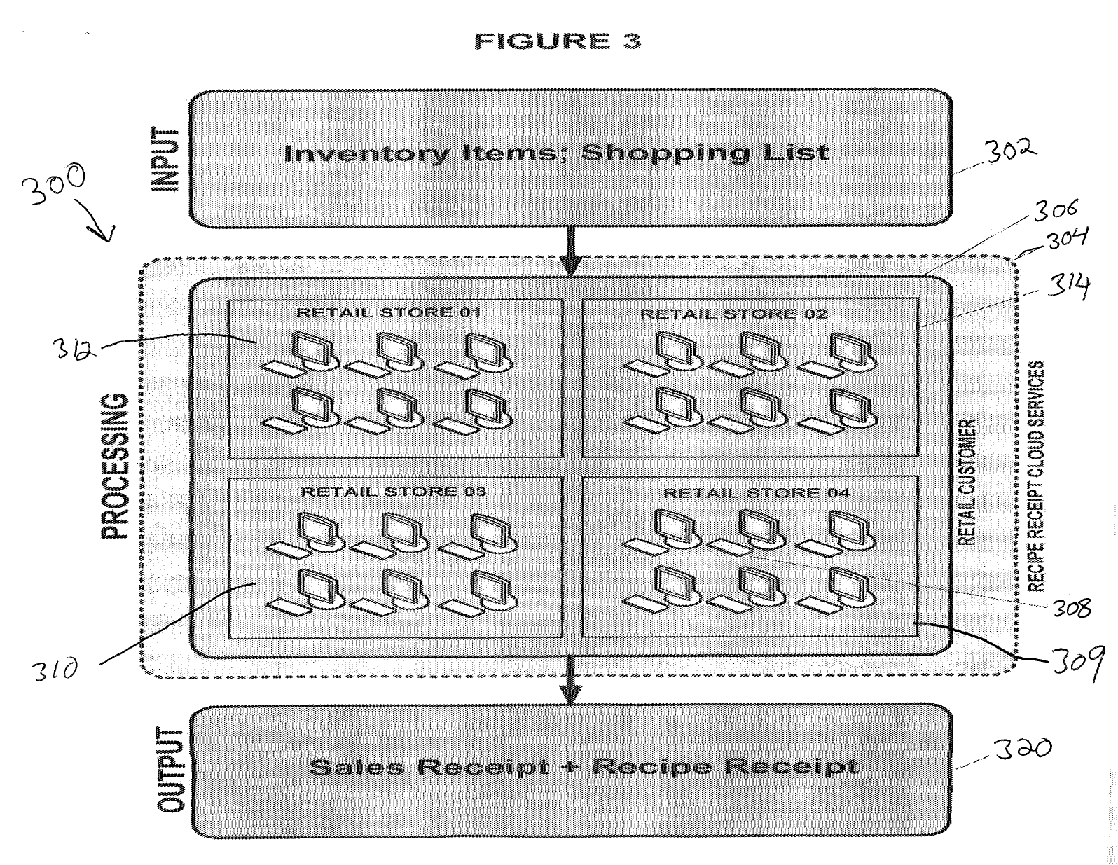

FIG. 3 is a block diagram to show the inter-relationships of the components of the recipe receipt system 300. This representation also shows the process map; signifying what is an input 302, process 304 (e.g., recipe receipt cloud services) and the output 320 out of the system 300. Input 302 may represent the inputs used under herein described processes or systems. The final shopping list of the customer may be used as input into the recipe receipt system 300. Process 304 may be the processing section where logical processing of the system 300 takes place. This section contains further sub section 306. A retail customer 306 may comprise one or more retail stores 309,310,312,314. Each store may have at least one or multiple point-of-sales systems, as described above, which may be loaded with recipe receipt processors 308. An output out of this system 300 may be a printed recipe receipt, which could be printed as an independent receipt, or an embedded, appended receipt for the end customer as represented in output 320.

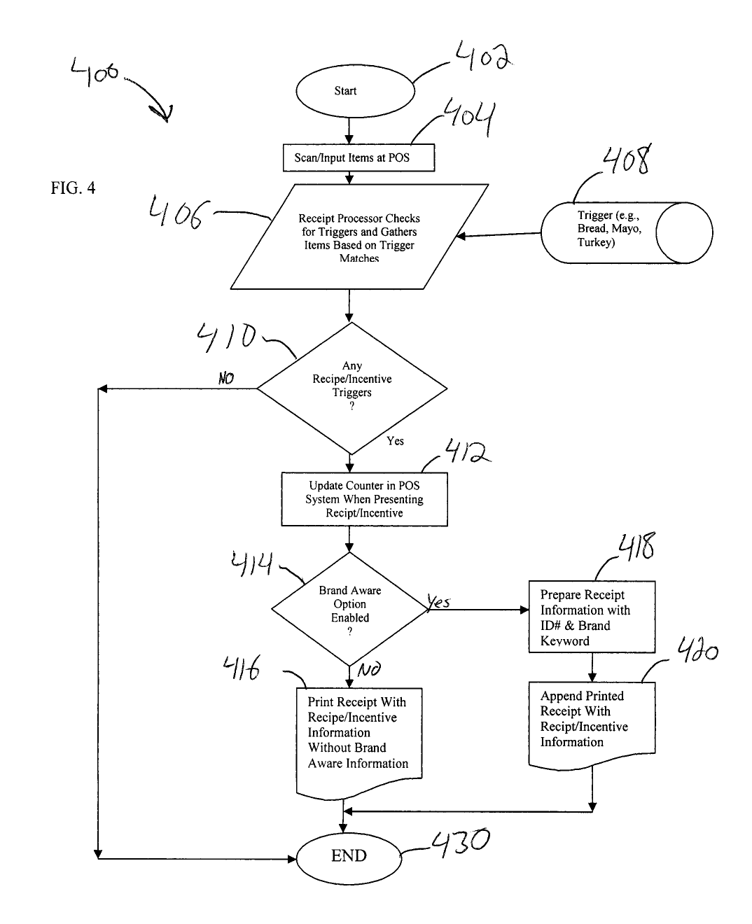

In FIG. 4 is shown a flowchart of a method 400 for a recipe/incentive process and algorithm, along with a brand aware option. A receipt may be embedded with a brand name for brand promotions by vendors, manufacturers of promoted products, and other interested parties. The recipe receipt cloud system may print recipes with brand name ingredients in place of generic ingredients in the recipe (e.g., if one of the ingredients in the recipe is “salt” and the brand aware function is enabled; the recipe may be printed with the ingredient as “brand+salt” instead of merely “salt”). The start 402 may proceed in a retail store where an end customer may be visiting various sections to collect items for shopping and bring selected items to be processed for payment at any of the POS systems in the store. Each item may be scanned by the scanner in the POS system (manned or unmanned) creating the sales receipt after payment. Besides scanning, the customer or personnel may input data regarding the selected item into the POS systems, as shown in FIG. 4 as “scan/input items at POS” 404. Once the sales receipt is printed and sent to the printer, a recipe receipt processor may collect the information from a sales receipt in the background and may send a copy of the sales receipt to the recipe receipt cloud services. In step 406, the receipt processor may check for triggers and gather items based on trigger matches, such as into categories of interest to vendors. The system may match incentives, recipes, and such, with the items purchased. For example, if the scan reveals that ethnic food items are purchased, the system may use those items for triggers to present appropriate recipes with the perceived ethnic nature of the purchases. For example, if a transaction includes scanned items comprising garbanzos, lemons, garlic, and sesame seeds, the system may provide a trigger for a falafel recipe.

At input 408 triggers may be provided (e.g., bread, mayonnaise, turkey). At step 410 a decision may occur as to whether any recipe/incentive triggers are present. If the triggers are not present, the method may proceed to end 430. If triggers are present, then in step 412 the method may proceed to update a counter in the POS system when presenting a receipt/incentive.

At step 414 a decision may occur as to whether a brand aware option is enabled. If the brand aware option is not enabled, the method 400 may proceed to step 416 to print a receipt with recipe/incentive information but without brand aware information.

From step 414, if instead a brand aware option is enabled, then the method 400 may proceed to step 418 for preparing receipt information with an identification number (ID#) and a brand keyword. At step 420 the method 400 may proceed with appending a printed receipt with receipt/incentive information and the prepared brand aware information.

The system may check for the triggers as mentioned regarding input 408 and match a sales receipt. The process may include using a Terminal ID Name and a secured Token. Each terminal added in the recipe receipt cloud services may have a unique terminal ID and a unique security token associated with the terminal. Any point of sale processor trying to connect to the recipe receipt cloud services may proceed through a validation or authorization check before the data is accepted, sent, or shared with the recipe receipt processor. Brand awareness is one of the feature sets offered by the recipe receipt cloud services for promoting the brands by the manufacturers. If the brand awareness feature set was enabled the recipe may be printed with embedded brand names. If the brand awareness feature set was disabled, a recipe may not be printed with embedded brand names. Step 430 may be the end of the process.

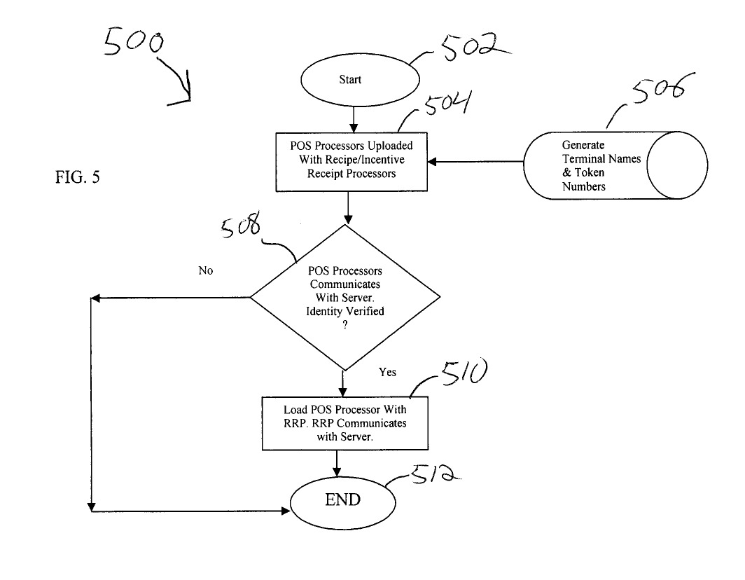

FIG. 5 shows a flow diagram that shows how to securely add recipe receipt processors to the recipe receipt cloud services. The method 500 may begin at start 502. A retail customer may agree to run the recipe receipt program in their retail stores. At step 504 the point of sale processor in the retail stores may be loaded with the recipe receipt processors. At input 506, the recipe receipt processor may be installed to the point of sales processor while adding the recipe receipt processor, also called the terminal in the recipe receipt cloud services to secure the system and verify the identity and authenticity of each requests made by the recipe receipt processors in the retails stores. Each terminal or recipe receipt processor may be identified by a Unique Code and a Security Token. If required in the future or for any reason the recipe receipt processor cannot be served in the program, the terminal or recipe receipt processor may be deleted from the system and it would stop all recipe receipt cloud services to serve the requests made by the recipe receipt processor. At step 508, the method 500 may verify the identity based on two parameters. In step 510 the recipe receipt processor may communicate to the recipe receipt cloud services if the identity is verified. The process may end at step 512.

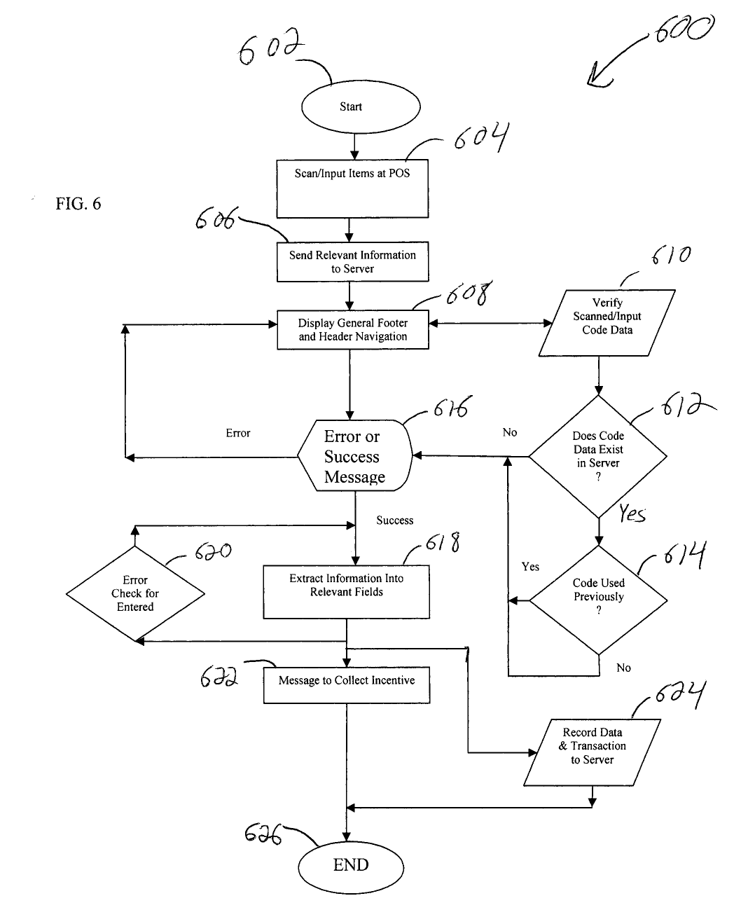

FIG. 6 shows a flow diagram of a method 600. The start of the process may be at 602. At step 604 an end customer may be in a retail store visiting various sections to collect items for shopping and finally bring the shopping cart with items in it to be processed for payment at any of the POS systems in the retail store. Each item may be scanned by the scanner in the POS system (manned or unmanned) creating the sales receipt after payment. If the sales receipt is printed and sent to a printer, the recipe receipt processor may collect information of the sales receipt in the background and sending the data to the recipe receipt cloud services. The sales receipt data may be prepared into a specific format to be understood by the recipe receipt cloud services. Step 606 may comprise sending relevant information to a server.

Each POS system in the store may print the sales receipt in different formats. At step 608 the method 600 may proceed to display general footer and header navigation. Step 610 may comprise verifying scanned/input code data while a decision in step 612 may determine whether code data exists in a server. If code data does exist in the server, then another decision 614 may consider whether the code was previously used.

If the code was previously used, then the vendor may proceed to check for an error message or a success message at step 616. If an error message results, then the method 600 may proceed to step 608. If a success message results, then the method 600 may proceed to step 618, which comprises extracting information into relevant fields. At step 622 a message to collect an incentive may be presented to an end customer, such as by being printed on a receipt. The method may then end at step 626. At step 620 entered data may be checked for errors. At step 624 data may be recorded and a transaction may be recorded to a server, then proceed eventually to end 626.

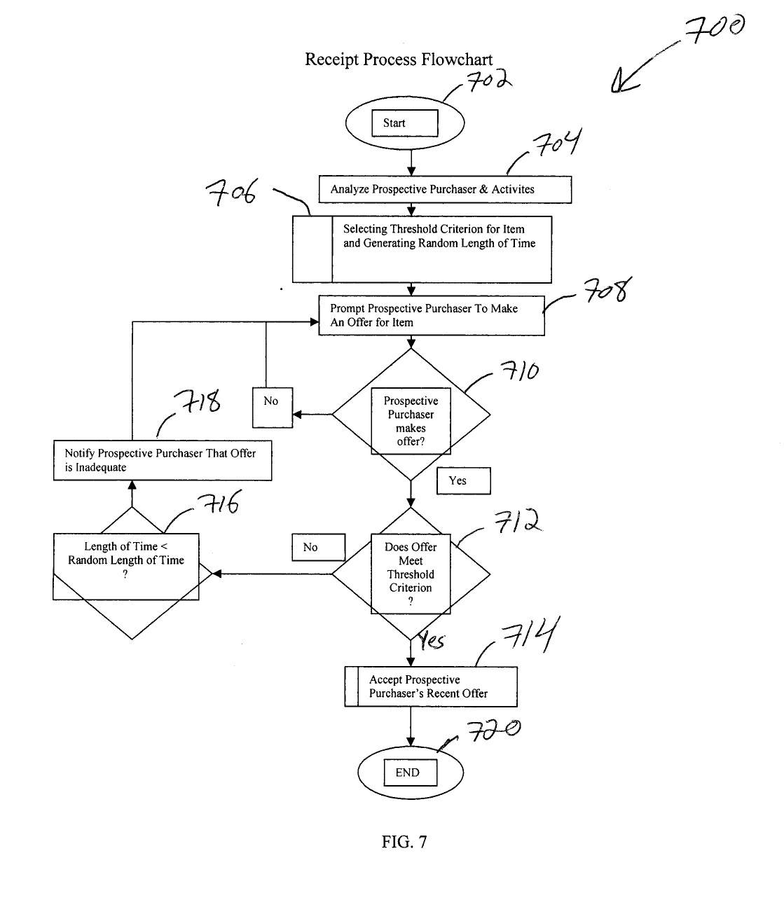

FIG. 7 shows a receipt process flowchart representing a method 700, which may start at 702. Step 704 may comprise analyzing a prospective purchaser and the purchaser's activities. Selecting a threshold criterion for an item and generating a random length of time may comprise step 706. Step 708 may comprise prompting a prospective purchaser to make an offer for an item.

At step 710 a decision considers whether the prospective purchaser makes an offer. If the prospective purchaser did make an offer, then step 712 considers whether the offer meets a threshold criterion. If the offer does meet the threshold criterion, then in step 714 the prospective purchaser's recent offer may be accepted.

If the prospective purchaser did not make an offer, then the method 700 may return in flow to step 708 to detect when an offer is made.

If the prospective purchaser did make an offer, but the offer did not meet a threshold criterion, at step 716 a decision determines whether the elapsed length of time was less than the random length of time generated in step 706. At step 718 if the length of time is greater than the generated random length of time, then at step 718 the offer is refused, notifying the prospective purchaser that the offer is inadequate, proceeding towards step 708. The method 700 may end at step 720.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein. As another example, any reference to a receipt may be considered to be a reference to another enhancement, such as a rebate, incentive, prize, or other enticement or enhancement. In another option, the data presented to a customer on a receipt may be provided via media other than paper, such as digital media, audio format, video, or other types of output.

We claim:

1. A method for printing receipts, comprising:
scanning items at a point-of-sale;
checking for triggers using point-of-sale processors from a compiled list of trigger matches;
gathering a category of items based on trigger matches;
determining whether recipe triggers exist;
determining whether incentive triggers exist;
presenting a receipt;
updating a counter in a point-of-sale system when presenting a receipt;
determining whether a brand aware option is enabled; and
printing a receipt with recipe and/or incentive information.

2. The method of claim 1, if a brand aware option is enabled, preparing receipt information with an identification number and brand keyword.

3. The method of claim 1, if a brand aware option is not enabled, the printed receipt is printed without brand aware information.

4. The method of claim 1, further comprising generating terminal names and token numbers.

5. The method of claim 4, further comprising uploading point-of-sale processors with recipe/incentive receipt processors.

6. The method of claim 5, further comprising verifying whether a point-of-sale processor communicates with a specific server.

7. The method of claim 6, further comprising loading the point-of-sale processor with the recipe/incentive receipt processor.

8. A method for distributing an incentive, comprising:
scanning an item at a point-of-sale during a consumer transaction;
transmitting relevant information from the consumer transaction to a designated server;
displaying general footer and header navigation;
verifying scanner or input code data;
determining whether the scanner or input code data is present in the designated server;
determining whether the scanner or input code data was used previously;
extracting information from the scanner or input code data into relevant fields;
recording the scanner or input code data;
recording the transaction; and
issuing information on a printed receipt regarding collecting an incentive.

9. The method of claim 8, if a brand aware option is enabled, preparing receipt information with an identification number and brand keyword.

10. The method of claim 8, if a brand aware option is not enabled, the printed receipt is printed without brand aware information.

11. The method of claim 8, further comprising generating terminal names and token numbers.

12. The method of claim 11, further comprising uploading point-of-sale processors with recipe/incentive receipt processors.

13. A method for distributing an incentive, comprising:
analyzing a prospective purchaser and purchaser activities;
selecting threshold criterion for an item;
generating a random length of time;
prompting the prospective purchaser to make an offer for the item;
determining whether an offer meets the threshold criterion;
comparing the elapsed time with the random length of time; and
accepting the prospective purchaser's recent offer.

14. The method of claim 13, further comprising notifying the prospective purchaser whether the recent offer is adequate.
